(19) United States
(12) Patent Application Publication
(10) Pub. No.: US 2018/0107493 A1
(43) Pub. Date: Apr. 19, 2018

(54) SYNCHRONOUS CONTROL METHOD AND DEVICE VIA EXTERNAL APPARATUS

(71) Applicants: Beijing Sunplus-EHue Tech Co., Ltd, Beijing (CN); Sunplus Technology Co., Ltd., Hsinchu (TW)

(72) Inventors: Peng-Fei TAN, Beijing (CN); Tai-Yun WANG, Beijing (CN); Wei QIN, Beijing (CN)

(73) Assignees: Beijing Sunplus-EHue Tech Co., Ltd, Beijing (CN); Sunplus Technology Co., Ltd., Hsinchu (TW)

(21) Appl. No.: 15/102,278

(22) PCT Filed: Nov. 6, 2015
(86) PCT No.: PCT/CN2015/094039

§ 371 Date: Jun. 7, 2016

(30) Foreign Application Priority Data
Nov. 6, 2014 (CN) 201410638616.1

(51) Int. Cl. G06F 9/44

(52) U.S. Cl. CPC G06F 9/4428

(57) ABSTRACT

A method and device applied in an Android data processing system for performing synchronous control via an external apparatus. A control message from the external apparatus is received via a communication channel connected to the external apparatus. A pre-stored event generation procedure is executed by an Android Shell user privilege to convert the control message from the external apparatus into an event message identifiable by the Android data processing system. The Android data processing system identifies the event message and generates a corresponding control event to perform corresponding operations based on the control event. The external apparatus is used to synchronously control the Android data processing system and variation on the Android data processing system is less.

This application is the 35 U.S.C. §371 national stage of PCT application PCT/CN2015/094039, filed Nov. 6, 2015which claims the benefit of People's Republic of China application serial no. 201410638616.1, filed on Nov. 6, 2014, the disclosure of which is hereby incorporated by reference.

### TECHNICAL FIELD

The disclosure relates in general to a synchronous control technology field, and more particularly to a synchronous control method and device via an external apparatus.

### BACKGROUND

Now, users may operate an Android data processing system, for example, a smart phone, PC or an on-board unit, via user interface to play the stored multimedia content (for example, music, video, photographs, audio books etc.) and also other entertainment operations (for example, games etc.). However, because of hardware and/or software limitations, the play and operation effects may be also limited.

Mirror image service for sharing images between two devices has wide application. In mirror image service, the source device provides image message to the external apparatus. The source device usually is a portable device which having smaller display screen, but the external apparatus usually has larger display. By mirror image service, the service of the synchronous control between the receiving device and the source device is more.

China patent application publication CN103530032, published on Jan. 22, 2014, discloses a mobile terminal, an image display device and a method for providing user interface using the same. A method for controlling a plurality of mobile device connected to an external image display device is provided. The method includes: sending a screen message from a first mobile terminal to the image display device; sending a screen message from a second mobile terminal to the image display device; displaying a first mirror screen (which is corresponding to the screen message of the first mobile terminal) in a first region of the display of the image display device and displaying a second mirror screen (which is corresponding to the screen message of the second mobile terminal) in a second region of the display of the image display device; tracking a cursor (input from an input device of the image display device) on the display of the image display device; and when the cursor is in the first region of the display, controlling the first mobile terminal from the image display device, and when the cursor is in the second region of the display, controlling the second mobile terminal from the image display device. Screen messages of the mobile terminals are displayed and the mobile terminals are controlled, respectively. However, although the image display device can control display of the mobile terminals, the image display device cannot control play and operations of the mobile terminals. The play and operations of the mobile terminals are still performed via the mobile terminals to control the image display device for synchronous play and operations. However, the image display device cannot control play and operations of the mobile terminals.

China patent application publication CN103581337, published on Feb. 12, 2014, discloses a smart phone and an on-board unit. A method including the following steps: a) connecting the smart phone and the on-board unit via an independent display channel and a reactive channel; b) mirroring display contents from the smart phone to the display of the on-board unit via the display channel; and c) mirroring operations from the on-board unit to the smart phone via the reactive channel. The display channel is USB or HDMI. However, two channels between the smart phone and the on-board unit are needed, i.e. the display channel and the reactive channel. In the reference document, a root (system administrator) privilege of the smart phone is needed to implement image mirror transmission and processing on the smart phone. This may damage the current security system on the smart phone and thus the smart phone manufacture does not provide maintenance service to the smart phone.

China patent application publication CN101582053, published on Jan. 22, 2014, discloses to present a graphical user interface (“GUI”) on a remote control attachment device having a user input device and a display device. The GUI can be defined and managed by a portable media device, wherein the GUI is used to control the portable media device. The portable media device provides a GUI image to be displayed to the attachment. The attachment can send to the portable media device indicating a user control message of the input device in response to the displayed GUI image. The portable media device can process the user input to identify the user request and to take appropriate action which including updating the GUI image provided to the attachment. However, CN103581337 needs a root (system administrator) privilege of the smart phone to synchronous control the smart phone. This may damage the current security system on the smart phone and thus the smart phone manufacture does not provide maintenance service to the smart phone.

### SUMMARY

In order to solve one of the technical problems, the application provides a method and a device for performing synchronous control via an external apparatus. The root privilege of the Android data processing system is not required in performing synchronous control on the Android data processing system by the external apparatus, and thus variation on the Android data processing system is less.

In order to achieve one of the above objects, embodiments of the application provides the following implementations.

According to one embodiment, a method applied in an Android data processing system for performing synchronous control via an external apparatus is provided. The method includes: receiving a control message from the external apparatus via a communication channel connected to the external apparatus; executing a pre-stored event generation procedure by an Android Shell user privilege to convert the control message from the external apparatus into an event message identifiable by the Android data processing system; and identifying, by the Android data processing system, the event message and generating a corresponding control event to perform corresponding operations based on the control event.

In one embodiment of the application, the control event is a touch event.

In one embodiment of the application, the event message is an “input” event message or a “sendevent” event message.

In one embodiment of the application, pre-storage of the event generation procedure includes the following steps: storing the event generation procedure into a storage space of the Android data processing system via a copy command of an Android adjustment bridge ADB; encoding and storing an Android Java procedure into the Android data processing system to obtain a directory space which is controlled by the Android Java procedure; executing the Android Java procedure to copy the event generation procedure (which is stored in the storage space of the Android data processing system) into the directory space controlled by the Android Java procedure; and informing the Android Shell user privilege about a name of the directory space, and amending a document property of the event generation procedure as an executable document which is executable by other user privilege.

In one embodiment of the application, the Android Java procedure is stored into the Android data processing system in form of an Android application package apk.

In one embodiment of the application, execution of the pre-stored event generation procedure by the Android Shell user privilege is implemented via executing the event generation procedure (which is stored in the directory space) by an “adb Shell” command input into the Android data processing system.

In one embodiment of the application, pre-storage of the event generation procedure includes the following steps: storing the event generation procedure into a directory (which is writable by the Android Shell user privilege) of a storage space of the Android data processing system by a copy command of an Android adjustment bridge ADB; and amending a property of the procedure as an executable document having “s-property” via an “adb” Shell command of the Android adjustment bridge ADB.

In one embodiment of the application, pre-storage of the event generation procedure includes the following steps: establishing a new directory in a directory (which is writable by the Android Shell user privilege) of a storage space of the Android data processing system; setting a property of the new directory as “t-property” via a copy command of an Android adjustment bridge ADB; storing the event generation procedure into the new “t-property” directory of the storage space of the Android data processing system by the copy command of the Android adjustment bridge ADB; and amending a property of the procedure as an executable document having “s-property” via an “adb” Shell command of the Android adjustment bridge ADB.

In one embodiment of the application, the step of executing the pre-stored event generation procedure by the Android Shell user privilege is achieved by calling the event generation procedure by a procedure of an Android application package apk.

In one embodiment of the application, the communication channel is implemented by corresponding a TCP port of the Android data processing system with a TCP port of the external display device.

In one embodiment of the application, the communication channel is implemented by a USB cable.

In one embodiment of the application, the communication channel is implemented by USB network share.

In one embodiment of the application, the method further includes: amending a property of a SELinux context of the event generation procedure by a command, and thus the event generation procedure is executed by the Android Shell user privilege.

In one embodiment of the application, the control message is a touch message.

According to one embodiment, a method applied in an external apparatus for performing synchronous control on an Android data processing system is provided. The method includes: receiving a user control command and processing the received control command into a control message; and sending the control message to the Android data processing system via a communication channel to control the Android data processing system for performing corresponding operations based on the control message.

In one embodiment of the application, the communication channel is implemented by corresponding a TCP port of the Android data processing system with a TCP port of the external display device.

In one embodiment of the application, the communication channel is implemented by a USB cable.

In one embodiment of the application, the communication channel is implemented by USB network share.

In one embodiment of the application, the control command is a touch command.

According to one embodiment, a device applied in an Android data processing system for performing synchronous control via an external apparatus is provided. The device includes: a message receiving module for receiving a control message from the external apparatus via a communication channel connected to the external apparatus; a message generation module for executing a pre-stored event generation procedure by an Android Shell user privilege to convert the control message from the external apparatus into an event message identifiable by the Android data processing system; and an event generation module for identifying the event message by the Android data processing system and generating a corresponding control event to perform corresponding operations based on the control event.

According to one embodiment, a device applied in an external apparatus for performing synchronous control on an Android data processing system is provided. The device includes: a message generation module for receiving a user control command and processing the received control command into a control message; and a message transmission module for sending the control message to the Android data processing system via a communication channel to control the Android data processing system for performing corresponding operations based on the control message.

From the above implementation, in the application, the control message from the external apparatus is received via a communication channel connected to the external apparatus. Android Shell user privilege executes the pre-stored event generation procedure to convert the control message from the external apparatus into an event message which is identifiable by the Android data processing system. The Android data processing system identifies the event message and generates a corresponding control event. Thus, the root privilege of the Android data processing system is not required in performing synchronous control on the Android data processing system by the external apparatus, and thus variation on the Android data processing system is less.

### BRIEF DESCRIPTION OF THE DRAWINGS

FIG. 1 shows a structure diagram for an Android data processing system according to one embodiment of the application.

FIG. 2 shows a flow chart for a synchronous control method via an external apparatus according to one embodiment of the application.

FIG. 3 shows a pre-storage flow chart for an event generation procedure of a synchronous control method via an external apparatus according to one embodiment of the application.

FIG. 4 shows a pre-storage flow chart for an event generation procedure of a synchronous control method via an external apparatus according to one embodiment of the application.

FIG. 5 shows a pre-storage flow chart for an event generation procedure of a synchronous control method via an external apparatus according to one embodiment of the application.

FIG. 6 shows a structure diagram for an external apparatus according to one embodiment of the application.

FIG. 7 shows a pre-storage flow chart for an event generation procedure of a synchronous control method via an external apparatus according to one embodiment of the application.

FIG. 8 shows a structure diagram for a device for performing synchronous control via an external apparatus according to one embodiment of the application.

FIG. 9 shows a structure diagram for an event generation device of a device for performing synchronous control via an external apparatus according to one embodiment of the application.

FIG. 10 shows a structure diagram for an event generation device of a device for performing synchronous control via an external apparatus according to one embodiment of the application.

FIG. 11 shows a structure diagram for an event generation device of a device for performing synchronous control via an external apparatus according to one embodiment of the application.

FIG. 12 shows a structure diagram for a device for performing synchronous control via an external apparatus according to one embodiment of the application.

FIG. 13 shows one implementation of the application.

FIG. 14 shows another implementation of the application.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

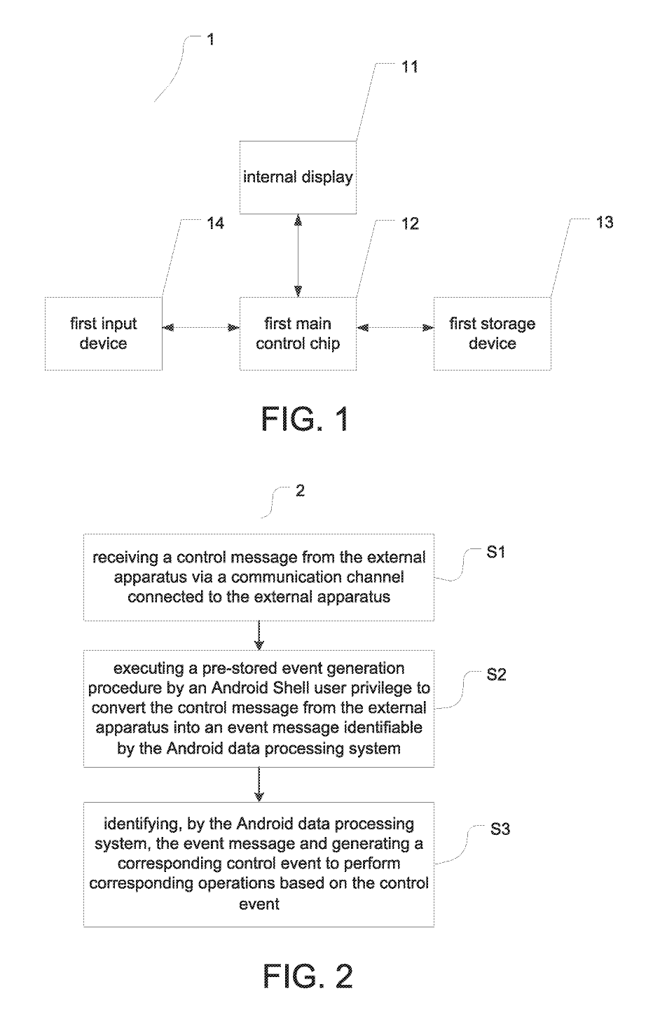

Refer to FIG. 1. An Android data processing system refers to an electronic device 1 having data processing functions, including for example but not limited by, an Android mobile phone, an Android computer, an Android PDA, or an Android on-board unit. The hardware of the electronic device 1 includes an internal display 11, a first main control chip 12, a first storage device 13 and a first input device 14. The first input device 14 is for receiving user input commands. The first storage device 13 is for storing applications and for accessing data. The internal display 11 is for displaying received or processed image data. The first main control chip 12 is for controlling operations of the functional devices.

Refer to FIG. 6. The external apparatus includes an electronic device 6 (for example, a mobile phone, a computer, a PAD or an on-board unit) having an external display. The hardware of the external display device include: an external display 61, a second main control chip 62, a second storage device 63 and a second input device 64.

In one implementation field for the application, the Android data processing system may be a mobile phone and the external apparatus may be an on-board unit. Synchronous control is performed on the mobile phone via the on-board unit.

In another implementation field for the application, the Android data processing system may be an on-board unit and the external apparatus may be a mobile phone. Synchronous control is performed on the on-board unit via the mobile phone.

In the Android data processing system, the first main control chip 12 executes applications stored in the first storage device 13 for data processing. User privileges of the Android data processing system include a regular user privilege and a root user privilege (system administrator) privilege. Only the root user privilege is allowed to generate a control event based on a control message which is from the external apparatus and received by the Android data processing system. On the contrary, the regular user privilege is not allowed to directly generate a control event based on a control message which is from the external apparatus and received by the Android data processing system. If for performing synchronous control on the Android data processing system, the Android data processing system changes its root system, then the security protection system of the Android data processing system may be damaged and thus the manufacture does not maintain the damaged Android data processing system.

In the application, the control message from the external apparatus is received via a communication channel connected to the external apparatus. Android Shell user privilege executes the pre-stored event generation procedure to convert the control message from the external apparatus into an event message which is identifiable by the Android data processing system. The Android data processing system identifies the event message and generates a corresponding control event. Thus, the root privilege of the Android data processing system is not required in performing synchronous control on the Android data processing system via the external apparatus, and thus variation on the Android data processing system is less.

Of course, any technical implementation of the application does not have to achieve all of the above advantages.

For the skilled person in the art to understand the technical implementations of the application, the technical implementations of the application are described clearly and entirely by referring to the accompanying drawings. However, the embodiments described in the application are just a part of embodiments of the application, not all embodiments of the application. After understanding the embodiments described in the application, other embodiments obtained by the skilled person in the art are within the scope and spirit of the application.

One embodiment of the application provides a synchronous control method via an external apparatus, which is suitable to Android data processing system. Refer to FIG. 1. An Android data processing system refers to an electronic device 1 having data processing functions, including for example but not limited by, an Android mobile phone, an Android computer, an Android PDA, or an Android on-board unit. The hardware of the electronic device 1 includes an internal display 11, a first main control chip 12, a first storage device 13 and a first input device 14.

Refer to FIG. 2. In one embodiment of the application, the synchronous control method via an external apparatus includes steps S1-S3.

In step S1, a control message from the external apparatus is received via a communication channel connected to the external apparatus.

Practically, the external apparatus may be an on-board unit which has processing and display functions. Users may input control commands to the external apparatus by touching the input module. In other words, the control message may be the touch message. The external apparatus processes the received user input command to obtain the control message and sends the control message to the Android data processing system via the communication channel. Because input into the external apparatus is easier than input into the Android data processing system, the application improves user experience and user input.

In step S2, the pre-stored event generation procedure is executed by Android Shell user privilege to convert the control message from the external apparatus into an event message identifiable by the Android data processing system.

Practically, the Android system provides an “input” command and a “sendevent” command line procedure. The “input” command and the “sendevent” command line procedure may be executed in the Android adjustment shell layer “adb” Shell. In the application, the control message received by the Android data processing system is converted into the “input” command event and the “sendevent” command event, i.e. the event message identifiable by the Android data processing system.

In the application, via the “input” command line procedure and the “sendevent” command line procedure provided by the Android data processing system, the Android Shell user privilege executes the pre-stored event generation procedure, without the root user privilege. Thus, the control message sent from the external apparatus is converted into the event message identifiable by the Android data processing system.

In the step S3, the Android data processing system identifies the event message and generates a corresponding control event to perform the corresponding operations based on the control event.

In the application, the Android data processing system generates the corresponding control event based on the “input” event message and the “sendevent” event message which are converted from the received control message. Thus, the Android data processing system is synchronously controlled to perform the corresponding operations.

In the embodiment of the application, the control message sent from the external apparatus is received via a communication channel connected to the external apparatus. The pre-stored event generation procedure is executed by Android Shell user privilege to convert the control message from the external apparatus into an event message identifiable by the Android data processing system. The Android data processing system identifies the event message and generates a corresponding control event to perform the corresponding operations based on the control event. Thus, the root privilege of the Android data processing system is not required in performing synchronous control on the Android data processing system, and thus variation on the Android data processing system is less.

One embodiment of the application provides a synchronous control method via an external apparatus, which is suitable to Android data processing system. The method includes the following steps S1-S2.

In step S1, a control message from the external apparatus is received via a communication channel connected to the external apparatus.

Practically, the external apparatus may be an on-board unit which has processing and display functions. Users may input control command to the external apparatus by touching the input module. In other words, the control message may be the touch message. The external apparatus processes the received user input command to obtain the control message and sends the control message to the Android data processing system via the communication channel. Because input into the external apparatus is easier than input into the Android data processing system, the application improves user experience and user input.

In step S2, the pre-stored event generation procedure is executed by Android Shell user privilege to convert the control message from the external apparatus into an event message identifiable by the Android data processing system.

Practically, the Android system provides “input” and “sendevent” command line procedures. The “input” and “sendevent” command line procedures may be executed in the Android adjustment shell layer “adb” Shell. In the application, the control message received by the Android data processing system is converted into the “input” and “sendevent” command events, i.e. the event message identifiable by the Android data processing system.

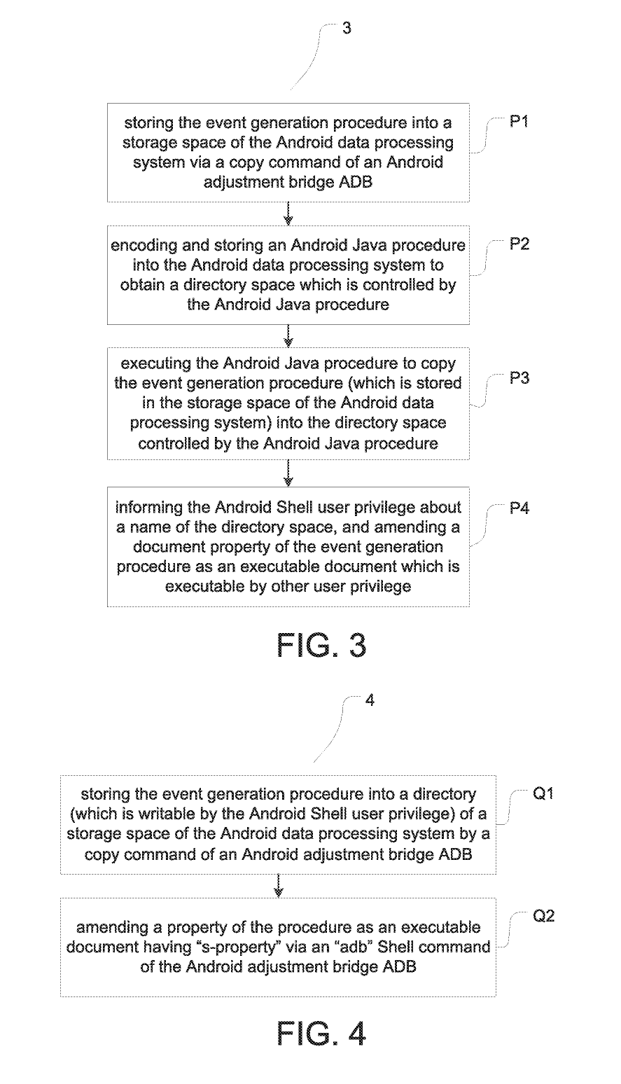

Refer to FIG. 3. The pre-storage method 3 for the event generation procedure includes the following steps.

In the step P1, the event generation procedure is stored into a storage space of the Android data processing system via a copy command of the Android adjustment bridge ADB.

Practically, the storage space of the Android data processing system is a SD card of the Android data processing system. The copy command of the Android adjustment bridge ADB is usually “adb push” command or “adb Shell copy” command.

Because the Android Shell user privilege of the Android adjustment bridge ADB does not have a privilege to directly execute the event generation procedure on the SD card, there is a need to put the event generation procedure into a location where the Android Shell user privilege of the Android adjustment bridge ADB is allowed to execute the event generation procedure, and to assign the Android Shell user privilege of the Android adjustment bridge ADB with a privilege to execute the event generation procedure.

Therefore, after the event generation procedure is stored into the SD card of the Android data processing system, steps P2-P4 are included.

In the step P2, an Android Java procedure is encoded and stored into the Android data processing system to obtain a directory space which is controlled by the Android Java procedure.

Practically, the Android Java procedure is stored into the Android data processing system in the form of an Android application package apk. The Android system will establish a directory space for the Android Java procedure for execution and data storage of Android Java procedure. The directory space is controlled by the Android Java procedure.

In the P3, the Android Java procedure is executed to copy the event generation procedure (which is stored in the storage space of the Android data processing system) into the directory space controlled by the Android Java procedure.

P4: The Android Shell user privilege is informed about the name of the directory space, and the document property of the event generation procedure is amended as an executable document which is executable by other user privilege.

In the application, the event generation procedure is placed into a space where the Shell user privilege of the Android adjustment bridge ADB is allowed to execute the event generation procedure, and the Shell user privilege of the Android adjustment bridge ADB is assigned with a privilege to execute the event generation procedure. In the application, the Shell user privilege of the Android adjustment bridge ADB can directly execute the event generation procedure stored in the SD card by executing the executable document in the Android Java procedure directory. Thus, the received control message is converted into an event message identifiable to the Android data processing system.

In implementation of the application, execution of the pre-stored event generation procedure by the Android Shell user is implemented via executing the event generation procedure (which is stored in the directory space) by the “adb Shell” command input into the Android data processing system.

In the step S3, the Android data processing system identifies the event message and generates a corresponding control event to perform the corresponding operations based on the control event.

In the application, the Android data processing system generates the corresponding control event based on the “input” and the “sendevent” event messages which are converted from the received control message. Thus, the Android data processing system is synchronously controlled to perform the corresponding operations.

In the embodiment of the application, the control message sent from the external apparatus is received via a communication channel connected to the external apparatus. The pre-stored event generation procedure is executed by Android Shell user privilege to convert the control message from the external apparatus into an event message identifiable by the Android data processing system. The Android data processing system identifies the event message and generates a corresponding control event to perform the corresponding operations based on the control event. Thus, the root privilege of the Android data processing system is not required in performing synchronous control on the Android data processing system, and thus variation on the Android data processing system is less.

One embodiment of the application provides a synchronous control method via an external apparatus, which is suitable to Android data processing system. The method includes the following steps.

In step S1, a control message from the external apparatus is received via a communication channel connected to the external apparatus.

Practically, the external apparatus may be an on-board unit which has processing and display functions. Users may input control commands to the external apparatus by touching the input module. In other words, the control message may be the touch message. The external apparatus processes the received user input command to obtain the control message and sends the control message to the Android data processing system via the communication channel. Because input into the external apparatus is easier than input into the Android data processing system, the application improves user experience and user input.

In step S2, the pre-stored event generation procedure is executed by Android Shell user privilege to convert the control message from the external apparatus into an event message identifiable by the Android data processing system.

Practically, the Android system provides “input” and “sendevent” command line procedures. The “input” and the “sendevent” command line procedures may be executed in the Android adjustment shell layer adb Shell. In the application, the control message received by the Android data processing system is converted into the “input” and the “sendevent” command events, i.e. the event message identifiable by the Android data processing system.

Practically, refer to FIG. 4. The pre-storage method 4 for the event generation procedure includes the following steps.

In the step Q1, the event generation procedure is stored into a directory (which is writable by the Shell user privilege) of the storage space of the Android data processing system by the copy command of the Android adjustment bridge ADB.

The event generation procedure is stored into a directory (for example, /data/local/tmp, which is writable by the Shell user privilege) of the SD card of the Android data processing system. The ADB copy command is usually the adb push command or the adb Shell copy command.

Because the Shell user privilege of the Android adjustment bridge ADB does not have the privilege to directly execute the event generation procedure on the SD card, there is a need to put the event generation procedure into a space where the Shell user privilege of the Android adjustment bridge ADB can execute the event generation procedure and to assign the Shell user privilege of the Android adjustment bridge ADB with a privilege to execute the event generation procedure.

Therefore, after the event generation procedure is stored into the SD card of the Android data processing system, step Q2 is included.

In the Q2, the property of the procedure is amended as an executable document having “s-property” via the adb Shell command of the Android adjustment bridge ADB.

“s-property” refers to SetUID, which indicates an owner privilege of this document in execution of an executable procedure (or document). If an executable procedure has “s-property”, then the user privilege which executes the executable document has the Owner privilege on this executable document. After the property of the procedure is amended as “s-property” via the adb Shell command of the ADB copy command, if other user privilege is used in executing the procedure, other user privilege still has the Shell privilege. “Other user privilege” refers to the regular Android Java procedure of the Java layer. That is, even if the regular Android Java procedure of the Java layer is used in executing the procedure, the Shell privilege is still assigned.

In practical implementation of the application, execution of the pre-stored event generation procedure by the Android Shell user privilege is to encode and execute the Android Java application procedure, wherein the Android Java application procedure executes the event generation procedure in all directory of the Shell privilege.

In the application, the event generation procedure is placed into a space where the Shell user privilege of the Android adjustment bridge ADB is allowed to execute the event generation procedure, and the Shell user privilege of the Android adjustment bridge ADB is assigned with a privilege to execute the event generation procedure. In the application, the Shell user privilege of the Android adjustment bridge ADB can directly execute the event generation procedure stored in the SD card by executing the executable document in the Android Java procedure directory. Thus, the received control message is converted into an event message identifiable to the Android data processing system.

In the step S3, the Android data processing system identifies the event message and generates a corresponding control event to perform the corresponding operations based on the control event.

In the application, the Android data processing system generates the corresponding control event based on the “input” and the “sendevent” event messages which are converted from the received control message. Thus, the Android data processing system is synchronously controlled to perform the corresponding operations.

In the embodiment of the application, the control message sent from the external apparatus is received via a communication channel connected to the external apparatus. The pre-stored event generation procedure is executed by Android Shell user privilege to convert the control message from the external apparatus into an event message identifiable by the Android data processing system. The Android data processing system identifies the event message and generates a corresponding control event to perform the corresponding operations based on the control event. Thus, the root privilege of the Android data processing system is not required in performing synchronous control on the Android data processing system by the external apparatus, and thus variation on the Android data processing system is less.

One embodiment of the application provides a synchronous control method via an external apparatus, which is suitable to Android data processing system. The method includes the following steps S1-S3.

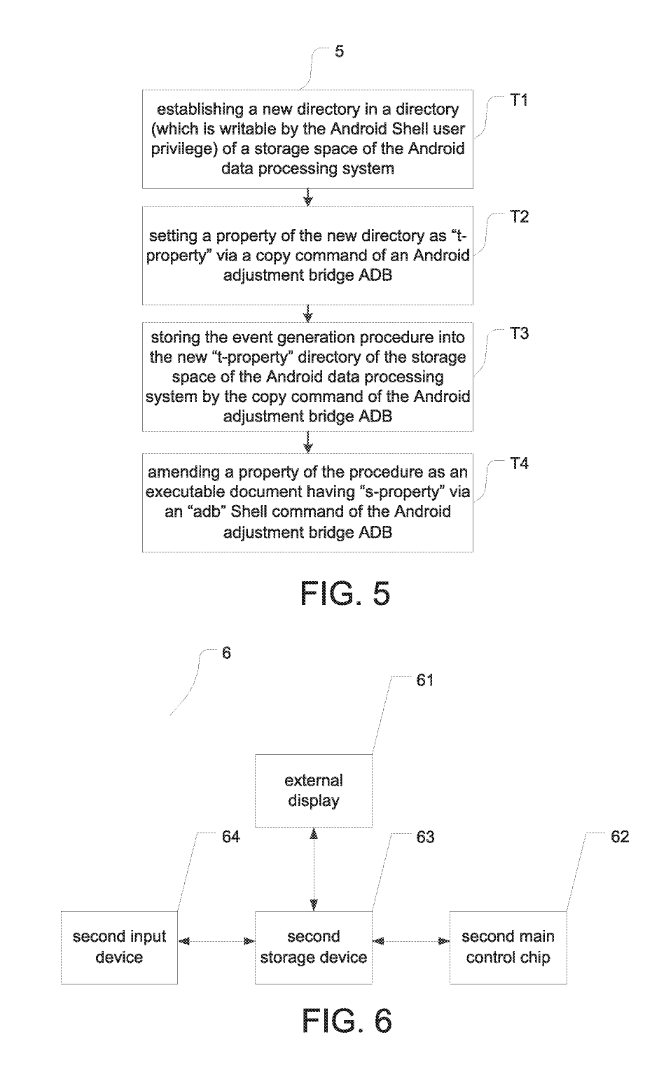

Practically, refer to FIG. 5. The pre-storage method 5 for the event generation procedure includes the following steps.

In the step T1, a new directory is established in a directory (which is writable by the Shell user privilege) of the storage space of the Android data processing system.

The new directory is established in a directory (for example,/data/local/tmp, which is writable by the Shell user privilege) of the SD card of the Android data processing system.

T2: the property of the new directory is set as “t-property” via the copy command of the Android adjustment bridge ADB.

The copy command of the Android adjustment bridge ADB is usually the adb push command or the adb Shell copy command.

“t-property” refers to a sticky bit. Usually, in Unix, in deleting a document, whether the user privilege owns the write privilege on the directory is considered. If the user privilege owns the write privilege on the directory, the user privilege is allowed to delete the document, without considering whether the user privilege is the owner of the document. For example, for a public shared directory, if there are a lot of user privileges who have write privilege on this directory, these user privileges also have deletion privilege on this directory. In the application, the new directory has “t-property” and thus, the owner of the document, or the owner of the directory or the root user privilege is allowed to delete the documents in this directory.

T3: the event generation procedure is stored into the new “t-property” directory of the storage space of the Android data processing system by the copy command of the Android adjustment bridge ADB.

After the event generation procedure is stored into the new “t-property” directory of the storage space of the Android data processing system by the copy command, other user privileges cannot delete the event generation procedure.

Because the Shell user privilege of the Android adjustment bridge ADB does not have the privilege to directly execute the event generation procedure on the SD card, there is a need to put the event generation procedure into a space where the Shell user privilege of the Android adjustment bridge ADB can execute the event generation procedure and to assign the Shell user privilege of the Android adjustment bridge ADB with a privilege to execute the event generation procedure.

Therefore, after the event generation procedure is stored into the SD card of the Android data processing system, step T4 is included.

In the step T4, the property of the procedure is amended as an executable document having “s-property” via the adb Shell command of the Android adjustment bridge ADB.

“s-property” refers to SetUID, which indicates an owner privilege of this document in execution of an executable procedure (or document). If an executable procedure has “s-property”, then the user privilege which executes the executable document has the Owner privilege on this executable document. After the property of the procedure is amended as “s-property” via the adb Shell command of the ADB copy command, if other user privilege is used in executing the procedure, other user privilege still has the Shell privilege. “Other user privilege” refers to the regular Android Java procedure of the Java layer. That is, even if the regular Android Java procedure of the Java layer is used in executing the procedure, the Shell privilege is still assigned.

In the application, the event generation procedure is placed into a space where the Shell user privilege of the Android adjustment bridge ADB is allowed to execute the event generation procedure, and the Shell user privilege of the Android adjustment bridge ADB is assigned with a privilege to execute the event generation procedure. In the application, the Shell user privilege of the Android adjustment bridge ADB can directly execute the event generation procedure stored in the SD card by executing the executable document in the Android Java procedure directory. Thus, the received control message is converted into an event message identifiable to the Android data processing system.

In the application, the Android data processing system generates the corresponding control event based on the “input” and the “sendevent” event message which is converted from the received control message. Thus, the Android data processing system is synchronously controlled to perform the corresponding operations.

In the embodiment of the application, the control message sent from the external apparatus is received via a communication channel connected to the external apparatus. The pre-stored event generation procedure is executed by Android Shell user privilege to convert the control message from the external apparatus into an event message identifiable by the Android data processing system. The Android data processing system identifies the event message and generates a corresponding control event to perform the corresponding operations based on the control event. Thus, the root privilege of the Android data processing system is not required in performing synchronous control on the Android data processing system, and thus variation on the Android data processing system is less.

One embodiment of the application provides a synchronous control method via an external apparatus, which is suitable to Android data processing system. The method includes the following steps.

In step S1, a control message from the external apparatus is received via a communication channel connected to the external apparatus.

The Android adjustment bridge ADB may correspond the TCP port of the Android data processing system with the TCP port of the external apparatus (for example, an on-board unit) which is connected via USB. For example, the command “adb forward tcp:100 tcp:200” corresponds the TCP port 200 of the Android data processing system with the TCP port 100 of the external apparatus (for example, an on-board unit) which executes the Android adjustment bridge. Thus, the Android data processing system opens the socket for TCP port 200 and the external apparatus (for example, an on-board unit) opens the socket for TCP port 100. The Android data processing system and the external apparatus may communicate with each other.

Thus, the communication channel is implemented by corresponding the TCP port of Android data processing system and the TCP port of the external apparatus. Practically, the communication channel is a USB cable.

In the embodiment of the application, the control message transmission between the Android data processing system and the external apparatus may be achieved even without WiFi wireless network or any wired network. The embodiment of the application is suitable in the environment where wireless data transmission is not available, for example, in a flying airplane or in the situation that a car drives into an area having poor wireless signal strength. Thus, the control message transmission between the Android data processing system and the external apparatus has wider application field. Further, in the embodiment of the application, the control message transmission between the Android data processing system and the external apparatus does not occupy the network bandwidth, the operations are convenient and simple, and the delay in the control message transmission is prevented.

In step S2, the pre-stored event generation procedure is executed by Android Shell user privilege to convert the control message from the external apparatus into an event message identifiable by the Android data processing system.

In the step S3, the Android data processing system identifies the event message and generates a corresponding control event to perform the corresponding operations based on the control event.

In the embodiment of the application, the control message sent from the external apparatus is received via a communication channel connected to the external apparatus. The pre-stored event generation procedure is executed by Android Shell user privilege to convert the control message from the external apparatus into an event message identifiable by the Android data processing system. The Android data processing system identifies the event message and generates a corresponding control event to perform the corresponding operations based on the control event. Thus, the root privilege of the Android data processing system is not required in performing synchronous control on the Android data processing system, and thus variation on the Android data processing system is less.

One embodiment of the application provides a synchronous control method via an external apparatus, which is suitable to Android data processing system. The method includes the steps S1-S3.

Practically, the communication channel is implemented by USB network share.

In the embodiment of the application, the control message transmission between the Android data processing system and the external apparatus may be achieved even without WiFi wireless network or any wired network. The embodiment of the application is suitable in the environment where wireless data transmission is not available, for example, in a flying airplane or in the situation that a car drives into an area having poor wireless signal strength. Thus, the control message between the Android data processing system and the external apparatus has wider application field. Further, in the embodiment of the application, the control message transmission between the Android data processing system and the external apparatus does not occupy the network bandwidth, the operations are convenient and simple, and the delay in the control message transmission is prevented.

In the embodiment of the application, the control message sent from the external apparatus is received via a communication channel connected to the external apparatus. The pre-stored event generation procedure is executed by Android Shell user privilege to convert the control message from the external apparatus into an event message identifiable by the Android data processing system. The Android data processing system identifies the event message and generates a corresponding control event to perform the corresponding operations based on the control event. Thus, the root privilege of the Android data processing system is not required in performing synchronous control on the Android data processing system, and thus variation on the Android data processing system is less.

One embodiment of the application provides a synchronous control method via an external apparatus, which is suitable to Android data processing system. The method includes the following steps S1-S3.

Practically, the method further includes: amending the property of the SELinux context of the event generation procedure by commands, and thus the event generation procedure is executed by the Android Shell user privilege.

SELinux is a Role-Based Access Control (RBAC) Linux promoted by NSA of US. In Linux, the safety regulation in the conventional UNIX privilege should be also compatible with the safety regulation in SELinux, and thus the privilege verification is passed. In practical implementation of the application, the property of the SELinux context of the event generation procedure is amended by a “chcon” command. In the application, the property of the SELinux context of the event generation procedure is amended as “u:object_r:system_file:s0” by the “chcon” command, and thus the event generation procedure is executed by the Android Shell user privilege.

Another embodiment of the application provides synchronous control method via an external apparatus, which is suitable for the Android data processing system. Refer to FIG. 6. The external apparatus includes an electronic device 6 (for example, an on-board unit) and having an external display. The hardware of the external apparatus includes: an external display 61, a second main control chip 62, a second storage device 63 and a second input device 64. Practically, the second input device 64 may be a touch panel and the user may input commands via the touch panel.

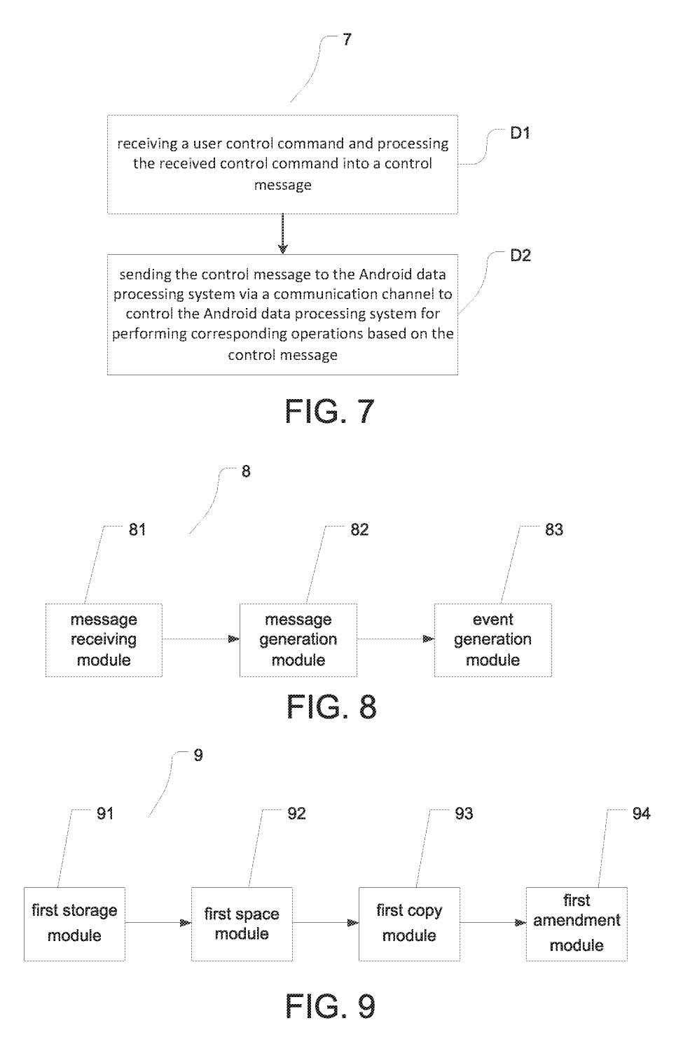

Refer to FIG. 7. The method includes the following steps D1-D2.

In the step D1, the control command input from the user is received and the received control command is processed into a control message.

Practically, the external apparatus may be an apparatus (for example, an on-board unit) having processing and display functions. Users may input the control command to the external apparatus via the input module (for example, a touch panel) and thus the control message may be a touch message. The external apparatus process the received user input command into the control message. The external apparatus sends the control message to the Android data processing system via the communication channel. Because input into the external apparatus is easier than input into the Android data processing system, the user experience is improved and user input is more convenient.

In the step D2, the control message is sent to the Android data processing system via the communication channel and the Android data processing system performs the corresponding operations based on the control message.

The Android adjustment bridge ADB may correspond the TCP port of the Android data processing system with the TCP port of the external apparatus (for example, an on-board unit) which is connected via USB. For example, the command “adb forward tcp:100 tcp:200” corresponds the TCP port 200 of the Android data processing system with the TCP port 100 of the external apparatus (for example, an on-board unit) which executes the Android adjustment bridge. Thus, the Android data processing system opens the socket for TCP port 200 and the external apparatus (for example, an on-board unit) opens the socket for TCP port 100. The Android data processing system and the external apparatus may communicate with each other.

Thus, the communication channel is implemented by corresponding the TCP port of Android data processing system and the TCP port of the external apparatus. Practically, the communication channel is a USB cable.

Besides, the communication channel in the application may be implemented by the USB network share.

In the embodiment of the application, the control message transmission between the Android data processing system and the external apparatus may be achieved even without WiFi wireless network or any wired network. The embodiment of the application is suitable in the environment where wireless data transmission is not available, for example, in a flying airplane or in the situation that a car drives into an area having poor wireless signal strength. Thus, the control message transmission between the Android data processing system and the external apparatus has wider application field. Further, in the embodiment of the application, the control message transmission between the Android data processing system and the external apparatus does not occupy the network bandwidth, the operations are convenient and simple, and the delay in the control message transmission is prevented.

In the embodiment of the application, the control message sent from the external apparatus is received via a communication channel connected to the external apparatus. The pre-stored event generation procedure is executed by Android Shell user privilege to convert the control message from the external apparatus into an event message identifiable by the Android data processing system. The Android data processing system identifies the event message and generates a corresponding control event to perform the corresponding operations based on the control event. Thus, the root privilege of the Android data processing system is not required in performing synchronous control on the Android data processing system by the external apparatus, and thus variation on the Android data processing system is less.

One embodiment of the application provides a device for performing synchronous control via an external apparatus, which is suitable for an Android data processing system. Refer to FIG. 1, the Android data processing system refers to an electronic device 1 having data processing functions, including for example but not limited by, an Android mobile phone, an Android computer, an Android PDA. The hardware of the electronic device 1 includes an internal display 11, a first main control chip 12, a first storage device 13 and a first input device 14.

Refer to FIG. 8. The device for performing synchronous control via an external apparatus according to one embodiment of the application includes a message receiving module 81, a message generation module 82 and an event generation module 83.

The message receiving module 81 is for receiving a control message from the external apparatus via a communication channel connected to the external apparatus.

The message generation module 82 is for executing the pre-stored event generation procedure via Android Shell user privilege to convert the control message from the external apparatus into an event message identifiable by the Android data processing system.

The event generation module 83 is for identifying the event message and generating a corresponding control event to perform the corresponding operations based on the control event.

Practically, the external apparatus may be an on-board unit which has processing and display functions. Users may input control commands to the external apparatus by touching the input module. In other words, the control message may be the touch message. The external apparatus processes the received user input command to obtain the control message and sends the control message to the Android data processing system via the communication channel. Because input into the external apparatus is easier than input into the Android data processing system, the application improves user experience and user input.

The Android system provides “input” and “sendevent” command line procedures. The “input” and the “sendevent” command line procedures may be executed in the Android adjustment shell layer adb Shell. In the application, the control message received by the Android data processing system is converted into the “input” and the “sendevent” command events, i.e. the event message identifiable by the Android data processing system.

In the application, via the “input” and the “sendevent” command line procedures provided by the Android data processing system, the Android Shell user privilege executes the pre-stored event generation procedure, without the root user privilege. Thus, the control message sent from the external apparatus is converted into the event message identifiable by the Android data processing system.

In the application, the Android data processing system generates the corresponding control event based on the “input” and the “sendevent” event messages which are converted from the received control message. Thus, the Android data processing system is synchronously controlled to perform the corresponding operations.

In the embodiment of the application, the control message sent from the external apparatus is received via a communication channel connected to the external apparatus. The pre-stored event generation procedure is executed by Android Shell user privilege to convert the control message from the external apparatus into an event message identifiable by the Android data processing system. The Android data processing system identifies the event message and generates a corresponding control event to perform the corresponding operations based on the control event. Thus, the root privilege of the Android data processing system is not required in performing synchronous control on the Android data processing system by the external apparatus, and thus variation on the Android data processing system is less.

One embodiment of the application provides a device for performing synchronous control via an external apparatus, which is suitable for an Android data processing system. The device includes a message receiving module 81, a message generation module 82 and an event generation module 83.

Practically, refer to FIG. 9. The pre-storage device 9 for the event generation procedure includes the modules 91-94.

The first storage module 91 is for storing the event generation procedure into a storage space of the Android data processing system via a copy command of the Android adjustment bridge ADB.

Practically, the storage space of the Android data processing system is a SD card of the Android data processing system. The copy command of the Android adjustment bridge ADB is usually “adb push” command or “adb Shell copy” command.

Because the Android Shell user privilege of the Android adjustment bridge ADB does not have a privilege to directly execute the event generation procedure on the SD card, there is a need to put the event generation procedure into a location where the Android Shell user privilege of the Android adjustment bridge ADB is allowed to execute the event generation procedure, and to assign the Android Shell user privilege of the Android adjustment bridge ADB with a privilege to execute the event generation procedure.

The first space module 92 is for encoding and storing an Android Java procedure into the Android data processing system to obtain a directory space which is controlled by the Android Java procedure.

Practically, the Android Java procedure is stored into the Android data processing system in the form of an Android application package apk. The Android system will establish a directory space for the Android Java procedure for execution and data storage of Android Java procedure. The directory space is controlled by the Android Java procedure.

The first copy module 93 is for executing the Android Java procedure to copy the event generation procedure (which is stored in the storage space of the Android data processing system) into the directory space controlled by the Android Java procedure.

The first amendment module 94 is for informing the Android Shell user privilege about the name of the directory space, and for amending the document property of the event generation procedure as an executable document which is executable by other user privilege.

In the application, the event generation procedure is placed into a space where the Shell user privilege of the Android adjustment bridge ADB is allowed to execute the event generation procedure, and the Shell user privilege of the Android adjustment bridge ADB is assigned with a privilege to execute the event generation procedure. In the application, the Shell user privilege of the Android adjustment bridge ADB can directly execute the event generation procedure stored in the SD card by executing the executable document in the Android Java procedure directory. Thus, the received control message is converted into an event message identifiable to the Android data processing system. “Other user privilege” refers to a regular Java procedure of Java layer.

In implementation of the application, execution of the pre-stored event generation procedure by the Android Shell user is implemented via executing the event generation procedure (which is stored in the directory space) by the “adb Shell” command input into the Android data processing system.

In the embodiment of the application, the control message sent from the external apparatus is received via a communication channel connected to the external apparatus. The pre-stored event generation procedure is executed by Android Shell user privilege to convert the control message from the external apparatus into an event message identifiable by the Android data processing system. The Android data processing system identifies the event message and generates a corresponding control event to perform the corresponding operations based on the control event. Thus, the root privilege of the Android data processing system is not required in performing synchronous control on the Android data processing system by the external apparatus, and thus variation on the Android data processing system is less.

One embodiment of the application provides a device for performing synchronous control via an external apparatus, which is suitable for an Android data processing system. The device includes a message receiving module 81, a message generation module 82 and an event generation module 83.

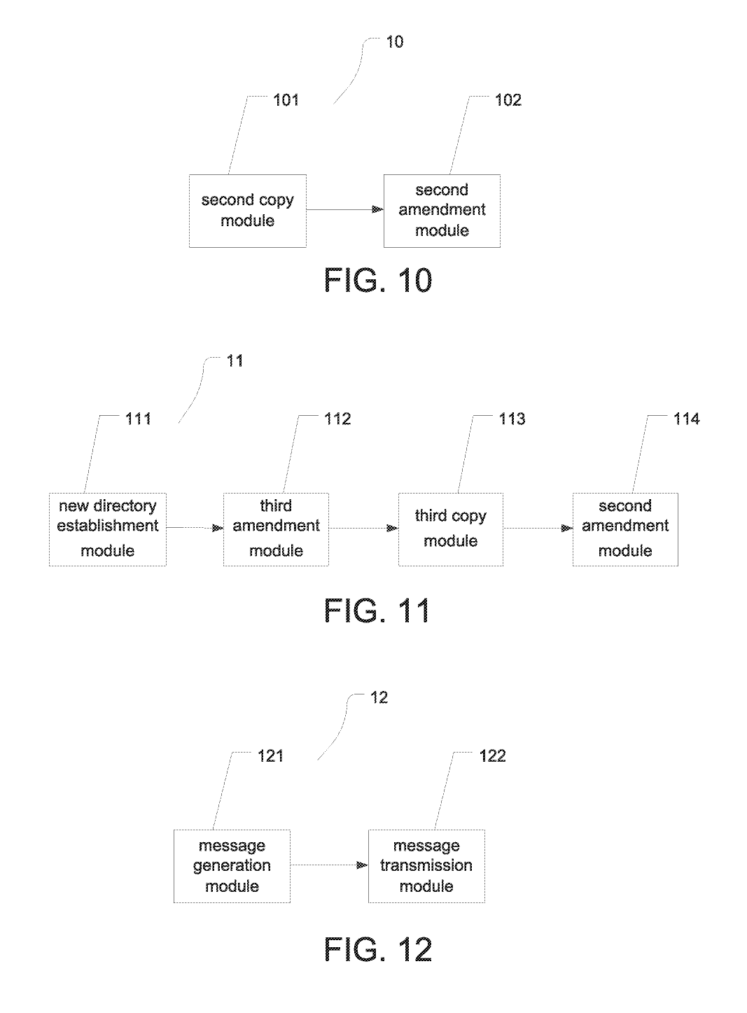

Practically, refer to FIG. 10. The pre-storage device 10 for the event generation procedure includes the modules 101-102.

The second copy module 101 is for storing the event generation procedure into a directory (which is writable by the Shell user privilege) of the storage space of the Android data processing system by the copy command of the Android adjustment bridge ADB.

The event generation procedure is stored into a directory (for example, /data/local/tmp, which is writable by the Shell user privilege) of the SD card of the Android data processing system. The ADB copy command is usually the adb push command or the adb Shell copy command.

Because the Shell user privilege of the Android adjustment bridge ADB does not have the privilege to directly execute the event generation procedure on the SD card, there is a need to put the event generation procedure into a space where the Shell user privilege of the Android adjustment bridge ADB can execute the event generation procedure and to assign the Shell user privilege of the Android adjustment bridge ADB with a privilege to execute the event generation procedure.

The second amendment module 102 is for amending the property of the procedure as an executable document having “s-property” via the adb Shell command of the Android adjustment bridge ADB.

“s-property” refers to SetUID, which indicates an owner privilege of this document in execution of an executable procedure (or document). If an executable procedure has “s-property”, then the user privilege which executes the executable document has the Owner privilege on this executable document. After the property of the procedure is amended as “s-property” via the adb Shell command of the ADB copy command, if other user privilege is used in executing the procedure, other user privilege still has the Shell privilege. “Other user privilege” refers to the regular Android Java procedure of the Java layer. That is, even if the regular Android Java procedure of the Java layer is used in executing the procedure, the Shell privilege is still assigned.

In the application, the event generation procedure is placed into a space where the Shell user privilege of the Android adjustment bridge ADB is allowed to execute the event generation procedure, and the Shell user privilege of the Android adjustment bridge ADB is assigned with a privilege to execute the event generation procedure. In the application, the Shell user privilege of the Android adjustment bridge ADB can directly execute the event generation procedure stored in the SD card by executing the executable document in the Android Java procedure directory. Thus, the received control message is converted into an event message identifiable to the Android data processing system.

In the embodiment of the application, the control message sent from the external apparatus is received via a communication channel connected to the external apparatus. The pre-stored event generation procedure is executed by Android Shell user privilege to convert the control message from the external apparatus into an event message identifiable by the Android data processing system. The Android data processing system identifies the event message and generates a corresponding control event to perform the corresponding operations based on the control event. Thus, the root privilege of the Android data processing system is not required in performing synchronous control on the Android data processing system, and thus variation on the Android data processing system is less.

One embodiment of the application provides a device for performing synchronous control via an external apparatus, which is suitable for an Android data processing system. The device includes a message receiving module 81, a message generation module 82 and an event generation module 83.

Practically, refer to FIG. 11. The pre-storage device 11 for the event generation procedure includes the modules 111-114.

The new directory establishment module 111 is for establishing a new directory in a directory (which is writable by the Shell user privilege) of the storage space of the Android data processing system.

The new directory is established in a directory (for example,/data/local/tmp, which is writable by the Shell user privilege) of the SD card of the Android data processing system.

The third amendment module 112 is for amending the property of the new directory as “t-property” via the copy command of the Android adjustment bridge ADB.

The copy command of the Android adjustment bridge ADB is usually the adb push command or the adb Shell copy command.

“t-property” refers to a sticky bit. Usually, in Unix, in deleting a document, whether the user privilege owns the write privilege on the directory is considered. If the user privilege owns the write privilege on the directory, the user privilege is allowed to delete the document, without considering whether the user privilege is the owner of the document. For example, for a public shared directory, if there are a lot of user privileges who have write privilege on this directory, these user privileges also have deletion privilege on this directory. In the application, the new directory has “t-property” and thus, the owner of the document, or the owner of the directory or the root user privilege is allowed to delete the documents in this directory.

The third copy module 113 is for storing the event generation procedure into the new “t-property” directory of the storage space of the Android data processing system by the copy command of the Android adjustment bridge ADB.

After the event generation procedure is stored into the new “t-property” directory of the storage space of the Android data processing system by the copy command, other user privileges cannot delete the event generation procedure.

Because the Shell user privilege of the Android adjustment bridge ADB does not have the privilege to directly execute the event generation procedure on the SD card, there is a need to put the event generation procedure into a space where the Shell user privilege of the Android adjustment bridge ADB can execute the event generation procedure and to assign the Shell user privilege of the Android adjustment bridge ADB with a privilege to execute the event generation procedure.

The second amendment module 114 is for amending the property of the procedure as an executable document having “s-property” via the adb Shell command of the Android adjustment bridge ADB.

“s-property” refers to SetUID, which indicates an owner privilege of this document in execution of an executable procedure (or document). If an executable procedure has “s-property”, then the user privilege which executes the executable document has the Owner privilege on this executable document. After the property of the procedure is amended as “s-property” via the adb Shell command of the ADB copy command, if other user privilege is used in executing the procedure, other user privilege still has the Shell privilege. “Other user privilege” refers to the regular Android Java procedure of the Java layer. That is, even if the regular Android Java procedure of the Java layer is used in executing the procedure, the Shell privilege is still assigned.

In the application, the event generation procedure is placed into a space where the Shell user privilege of the Android adjustment bridge ADB is allowed to execute the event generation procedure, and the Shell user privilege of the Android adjustment bridge ADB is assigned with a privilege to execute the event generation procedure. In the application, the Shell user privilege of the Android adjustment bridge ADB can directly execute the event generation procedure stored in the SD card by executing the executable document in the Android Java procedure directory. Thus, the received control message is converted into an event message identifiable to the Android data processing system.

In the embodiment of the application, the control message sent from the external apparatus is received via a communication channel connected to the external apparatus. The pre-stored event generation procedure is executed by Android Shell user privilege to convert the control message from the external apparatus into an event message identifiable by the Android data processing system. The Android data processing system identifies the event message and generates a corresponding control event to perform the corresponding operations based on the control event. Thus, the root privilege of the Android data processing system is not required in performing synchronous control on the Android data processing system by the external apparatus, and thus variation on the Android data processing system is less.

One embodiment of the application provides a device for performing synchronous control via an external apparatus, which is suitable for an Android data processing system. The device includes a message receiving module 81, a message generation module 82 and an event generation module 83.

The Android adjustment bridge ADB may correspond the TCP port of the Android data processing system with the TCP port of the external apparatus (for example, an on-board unit) which is connected via USB. For example, the command “adb forward tcp:100 tcp:200” corresponds the TCP port 200 of the Android data processing system with the TCP port 100 of the external apparatus (for example, an on-board unit) which executes the Android adjustment bridge. Thus, the Android data processing system opens the socket for TCP port 200 and the external apparatus (for example, an on-board unit) opens the socket for TCP port 100. The Android data processing system and the external apparatus may communicate with each other.

Thus, the communication channel is implemented by corresponding the TCP port of Android data processing system and the TCP port of the external apparatus. Practically, the communication channel is a USB cable.

In the embodiment of the application, the control message transmission between the Android data processing system and the external apparatus may be achieved even without WiFi wireless network or any wired network. The embodiment of the application is suitable in the environment where wireless data transmission is not available, for example, in a flying airplane or in the situation that a car drives into an area having poor wireless signal strength. Thus, the control message transmission between the Android data processing system and the external apparatus has wider application field. Further, in the embodiment of the application, the control message transmission between the Android data processing system and the external apparatus does not occupy the network bandwidth, the operations are convenient and simple, and the delay in the control message transmission is prevented.

In the embodiment of the application, the control message sent from the external apparatus is received via a communication channel connected to the external apparatus. The pre-stored event generation procedure is executed by Android Shell user privilege to convert the control message from the external apparatus into an event message identifiable by the Android data processing system. The Android data processing system identifies the event message and generates a corresponding control event to perform the corresponding operations based on the control event. Thus, the root privilege of the Android data processing system is not required in performing synchronous control on the Android data processing system by the external apparatus, and thus variation on the Android data processing system is less.

One embodiment of the application provides a device for performing synchronous control via an external apparatus, which is suitable for an Android data processing system. The device includes a message receiving module 81, a message generation module 82 and an event generation module 83.

Practically, the communication channel is implemented by USB network share.

In the embodiment of the application, the control message transmission between the Android data processing system and the external apparatus may be achieved even without WiFi wireless network or any wired network. The embodiment of the application is suitable in the environment where wireless data transmission is not available, for example, in a flying airplane or in the situation that a car drives into an area having poor wireless signal strength. Thus, the control message transmission between the Android data processing system and the external apparatus has wider application field. Further, in the embodiment of the application, the control message transmission between the Android data processing system and the external apparatus does not occupy the network bandwidth, the operations are convenient and simple, and the delay in the control message transmission is prevented.

In the embodiment of the application, the control message sent from the external apparatus is received via a communication channel connected to the external apparatus. The pre-stored event generation procedure is executed by Android Shell user privilege to convert the control message from the external apparatus into an event message identifiable by the Android data processing system. The Android data processing system identifies the event message and generates a corresponding control event to perform the corresponding operations based on the control event. Thus, the root privilege of the Android data processing system is not required in performing synchronous control on the Android data processing system by the external apparatus, and thus variation on the Android data processing system is less.

One embodiment of the application provides a device for performing synchronous control via an external apparatus, which is suitable for an Android data processing system. The device includes a message receiving module 81, a message generation module 82 and an event generation module 83.

Practically, the property of the SELinux context of the event generation procedure is amended by commands, and thus the event generation procedure is executed by the Android Shell user privilege.

SELinux is a Role-Based Access Control (RBAC) Linux promoted by NSA of US. In Linux, the safety regulation in the conventional UNIX privilege should be also compatible with the safety regulation in SELinux, and thus the privilege verification is passed. In practical implementation of the application, the property of the SELinux context of the event generation procedure is amended by a “chcon” command. In the application, the property of the SELinux context of the event generation procedure is amended as “u:object_r:system_file:s0” by the “chcon” command, and thus the event generation procedure is executed by the Android Shell user privilege.

Another embodiment of the application provides a device for performing synchronous control via an external apparatus, which is suitable for the external apparatus. Refer to FIG. 6. The external apparatus includes an electronic device 6 (for example, an on-board unit) and having an external display. The hardware of the external apparatus includes: an external display 61, a second main control chip 62, a second storage device 63 and a second input device 64.

Refer to FIG. 12. The device includes modules 121 and 122.

The message generation module 121 is for receiving the control command input from the user and for processing the received control command into a control message.

Practically, the external apparatus may be an apparatus (for example, an on-board unit) having processing and display functions. Users may input the control command to the external apparatus via the input module (for example, a touch panel) and thus the control message may be a touch message. The external apparatus process the received user input command into the control message. The external apparatus sends the control message to the Android data processing system via the communication channel. Because input into the external apparatus is easier than input into the Android data processing system, the user experience is improved and user input is more convenient.

The message transmission module 122 is for transmitting the control message to the Android data processing system via the communication channel and the Android data processing system performs the corresponding operations based on the control message.

The Android adjustment bridge ADB may correspond the TCP port of the Android data processing system with the TCP port of the external apparatus (for example, an on-board unit) which is connected via USB. For example, the command “adb forward tcp:100 tcp:200” corresponds the TCP port 200 of the Android data processing system with the TCP port 100 of the external apparatus (for example, an on-board unit) which executes the Android adjustment bridge. Thus, the Android data processing system opens the socket for TCP port 200 and the external apparatus (for example, an on-board unit) opens the socket for TCP port 100. The Android data processing system and the external apparatus may communicate with each other.

Thus, the communication channel is implemented by corresponding the TCP port of Android data processing system and the TCP port of the external apparatus. Practically, the communication channel is a USB cable.

Besides, the communication channel in the application may be implemented by the USB network share.

In the embodiment of the application, the control message transmission between the Android data processing system and the external apparatus may be achieved even without WiFi wireless network or any wired network. The embodiment of the application is suitable in the environment where wireless data transmission is not available, for example, in a flying airplane or in the situation that a car drives into an area having poor wireless signal strength. Thus, the control message transmission between the Android data processing system and the external apparatus has wider application field. Further, in the embodiment of the application, the control message transmission between the Android data processing system and the external apparatus does not occupy the network bandwidth, the operations are convenient and simple, and the delay in the control message transmission is prevented.

In the embodiment of the application, the control message sent from the external apparatus is received via a communication channel connected to the external apparatus. The pre-stored event generation procedure is executed by Android Shell user privilege to convert the control message from the external apparatus into an event message identifiable by the Android data processing system. The Android data processing system identifies the event message and generates a corresponding control event to perform the corresponding operations based on the control event. Thus, the root privilege of the Android data processing system is not required in performing synchronous control on the Android data processing system by the external apparatus, and variation on the Android data processing system is less.

Implementation of the application is described in the following two practical implementations.

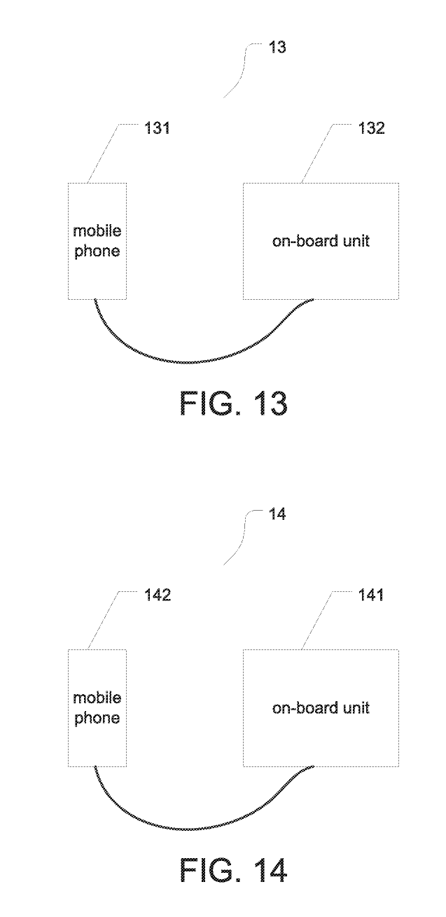

Refer to FIG. 13 which shows one implementation 13 of the application. The Android data processing system is a mobile phone 131 and the external apparatus is an on-board unit 132. The mobile phone 131 receives a control message from the on-board unit 132 via a communication channel connected to the on-board unit 132. The mobile phone 131 executes the pre-stored event generation procedure by Android Shell user privilege to convert the control message sent from the on-board unit 132 into an event message identifiable by the mobile phone 131. The mobile phone 131 identifies the event message and generates a corresponding control event for performing corresponding operations based on the control event. In the implementation of the application, users may send control message via the on-board unit 132 to control operations of the mobile phone 131. The mobile phone 131 does not need the Android root privilege, and the Android data processing system of the mobile phone 131 does not have much variation. Thus, the mobile phone 131 is still within the maintenance range of the mobile phone manufacture.

Refer to FIG. 14 which shows another implementation 14 of the application. The Android data processing system is an on-board unit 141 and the external apparatus is a mobile phone 142. The on-board unit 141 receives a control message from the mobile phone 142 via a communication channel connected to the mobile phone 142. The on-board unit 141 executes the pre-stored event generation procedure by Android Shell user privilege to convert the control message sent from the mobile phone 142 into an event message identifiable by the on-board unit 141. The on-board unit 141 identifies the event message and generates a corresponding control event for performing corresponding operations based on the control event. In the implementation of the application, users may send control message via the mobile phone 142 to control operations of the on-board unit 141. The on-board unit 141 does not need the Android root privilege, and the Android data processing system of the on-board unit 141 does not have much variation. Thus, the on-board unit 141 is still within the maintenance range of the mobile phone manufacture.

The devices provided in the above embodiments of the application may be implemented by computer procedures. Person skilled in the art would understand that the above implementations of the elements and the modules are one of possible implementations. If the elements or the modules are divided or segmented as other types, or even if the elements or the module are integrated together, as long as the above functions are achieved, these are still within the scope of the application.

Person skilled in the art should understand that the embodiments of the application may be implemented as a method, a device (or an apparatus) or a computer program product. Thus, the application may be implemented as pure hardware embodiments, pure software embodiments or embodiments having combination of hardware and software. Further, the application may be implemented as a computer program product which is implemented on one or more computer readable storage media (including for example but not limited by, a magnetic disk, a CD-ROM, an optical storage medium etc.) having computer readable program codes.

Description of the application is accompanied with the flow charts and/or the block diagram of the methods, the devices (apparatus) and the computer program product. It should be noted that the computer program codes may be used to implement each flow and/or block of the flow charts and/or the block diagram, or combination of the flows and/or blocks of the flow charts and/or the block diagram. The computer program codes may be provided to a general computer, a dedicated computer, an embedded processor or a processor of other programmable data processing device to form a machine, and a computer or a processor of other programmable data processing device may be used to form devices which may implement functions specified by one or more flows of the flow chart and/or one or more blocks of the block diagram.

The computer program codes may be stored in a computer readable storage which may guide a computer or other programmable data processing device in a specific operation way, so that codes of the computer readable storage includes a manufacture of command devices which implement functions specified by one or more flows of the flow chart and/or one or more blocks of the block diagram.

The computer program codes may be loaded into a computer or other programmable data processing device which executes a series of operation steps to generate computer-implemented processes. Thus, commands executed on a computer or other programmable data processing device may be provided to implement functions specified by one or more flows of the flow chart and/or one or more blocks of the block diagram.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A method applied in an Android data processing system for performing synchronous control via an external apparatus, the method including:
receiving a control message from the external apparatus via a communication channel connected to the external apparatus;
executing a pre-stored event generation procedure by an Android Shell user privilege to convert the control message from the external apparatus into an event message identifiable by the Android data processing system; and
identifying, by the Android data processing system, the event message and generating a corresponding control event to perform corresponding operations based on the control event.

2. The method according to claim 1, wherein the control event is a touch event.

3. The method according to claim 1, wherein the event message is an “input” event message or a “sendevent” event message.

4. The method according to claim 1, wherein pre-storage of the event generation procedure includes the following steps:
storing the event generation procedure into a storage space of the Android data processing system via a copy command of an Android adjustment bridge ADB;
encoding and storing an Android Java procedure into the Android data processing system to obtain a directory space which is controlled by the Android Java procedure;
executing the Android Java procedure to copy the event generation procedure (which is stored in the storage space of the Android data processing system) into the directory space controlled by the Android Java procedure; and
informing the Android Shell user privilege about a name of the directory space, and amending a document property of the event generation procedure as an executable document which is executable by other user privilege.

5. The method according to claim 4, wherein the Android Java procedure is stored into the Android data processing system in form of an Android application package apk.

6. The method according to claim 5, wherein execution of the pre-stored event generation procedure by the Android Shell user privilege is implemented via executing the event generation procedure (which is stored in the directory space) by an “adb Shell” command input into the Android data processing system.

7. The method according to claim 1, wherein pre-storage of the event generation procedure includes the following steps:
storing the event generation procedure into a directory (which is writable by the Android Shell user privilege) of a storage space of the Android data processing system by a copy command of an Android adjustment bridge ADB; and
amending a property of the procedure as an executable document having “s-property” via an “adb” Shell command of the Android adjustment bridge ADB.

8. The method according to claim 1, wherein pre-storage of the event generation procedure includes the following steps:
establishing a new directory in a directory (which is writable by the Android Shell user privilege) of a storage space of the Android data processing system;
setting a property of the new directory as “t-property” via a copy command of an Android adjustment bridge ADB;
storing the event generation procedure into the new “t-property” directory of the storage space of the Android data processing system by the copy command of the Android adjustment bridge ADB; and
amending a property of the procedure as an executable document having “s-property” via an “adb” Shell command of the Android adjustment bridge ADB.

9. The method according to claim 8, wherein the step of executing the pre-stored event generation procedure by the Android Shell user privilege is achieved by calling the event generation procedure by a procedure of an Android application package apk.

10. The method according to claim 1, wherein the communication channel is implemented by corresponding a TCP port of the Android data processing system with a TCP port of the external display device.

11. The method according to claim 10, wherein the communication channel is implemented by a USB cable.

12. The method according to claim 1, wherein the communication channel is implemented by USB network share.

13. The method according to claim 1, further including:
amending a property of a SELinux context of the event generation procedure by a command, and thus the event generation procedure is executed by the Android Shell user privilege.

14. The method according to claim 1, wherein the control message is a touch message.

15. A method applied in an external apparatus for performing synchronous control on an Android data processing system, the method including:
receiving a user control command and processing the received control command into a control message; and
sending the control message to the Android data processing system via a communication channel to control the Android data processing system for performing corresponding operations based on the control message.

16. The method according to claim 15, wherein the communication channel is implemented by corresponding a TCP port of the Android data processing system with a TCP port of the external display device.

17. The method according to claim 16, wherein the communication channel is implemented by a USB cable.

18. The method according to claim 15, wherein the communication channel is implemented by USB network share.

19. The method according to claim 15, wherein the control command is a touch command.

20. A device applied in an Android data processing system for performing synchronous control via an external apparatus, the device including:
a message receiving module for receiving a control message from the external apparatus via a communication channel connected to the external apparatus;
a message generation module for executing a pre-stored event generation procedure by an Android Shell user privilege to convert the control message from the external apparatus into an event message identifiable by the Android data processing system; and
an event generation module for identifying the event message by the Android data processing system and generating a corresponding control event to perform corresponding operations based on the control event.
